(19) United States
(12) Patent Application Publication
(10) Pub. No.: US 2024/0351146 A1
(43) Pub. Date: Oct. 24, 2024

(54) SYSTEM AND METHOD FOR CHECKING QUALITY OF LASER WELDING

(71) Applicant: HYUNDAI MOBIS CO., LTD., Seoul (KR)

(72) Inventor: Sung Hun WOO, Seoul (KR)

(73) Assignee: HYUNDAI MOBIS CO., LTD., Seoul (KR)

(21) Appl. No.: 18/218,227

(22) Filed: Jul. 5, 2023

(30) Foreign Application Priority Data
Apr. 20, 2023 (KR) 10-2023-0051938

(51) Int. Cl. B23K 31/12; B23K 26/03; B23K 26/21; B23K 26/70

(52) U.S. Cl. CPC B23K 31/125; B23K 26/03; B23K 26/21; B23K 26/702; B23K 31/006

(57) ABSTRACT

The present disclosure relates to a system and method for checking quality of laser welding. The system and method for checking quality of laser welding of the present disclosure relates to a technology capable of applying a consistent defect determination criterion for laser welding quality by applying an anomaly score that is inferred based on machine learning.

### CROSS-REFERENCE TO RELATED APPLICATIONS

This application claims priority under 35 U.S.C. § 119 to Korean Patent Application No. 10-2023-0051938, filed on Apr. 20, 2023, in the Korean Intellectual Property Office, the disclosure of which is incorporated herein by reference in its entirety.

### TECHNICAL FIELD

The following disclosure relates to a system and method for checking quality of laser welding, and more particularly, to a system and method for checking quality of laser welding that may use a machine learning-based network to perform learning processing on radiation plasma data generated during a laser welding process, and provide consistent quality inspection results in consideration of welding process environment trends reflected in the radiation plasma data and a welding process pattern determined to be normal.

### BACKGROUND

In general, detection technologies for each welding defect type (pore, non-welding, weak welding, etc.) have been performed through methods such as external inspection through vision inspection, non-destructive inspection through X-ray inspection, and visual inspection of workers.

However, the appearance inspection is a method of inspecting a change in appearance through an image, and may not inspect a fused state of an actual surface portion of a base material, and the non-destructive inspection is inconvenient to consider a special environment in which radiation is not necessarily exposed to workers.

In addition, since the visual inspection depends on workers, there is inevitably a problem of low detection reliability.

Accordingly, in order to solve the problems of the existing inspection method, technologies for determining welding defects by analyzing plasma generated during welding have been actively introduced in recent years.

In detail, by considering the fact that processing waves are emitted from a welded portion during laser welding, when the welding quality is good, the radiated processing wave (plasma) is converted into an optical signal (near infrared, near ultraviolet), which is then set as a reference waveform when the welding quality is good, upper and lower limit values are determined based on the set reference waveform, a good range (normal range) is set, and when the radiation plasma data is out of a good range, it is determined as defective.

However, as a result of applying to the actual mass production process, there is a problem of continuously monitoring and correcting the good range (quality determination standard) by the upper and lower limit values, and since the plasma sensing value is very sensitive, there is a problem in that the sensing value varies depending on a welded position (bead) even for the same molten metal.

In addition, when the process environment changes, there is a characteristic that the sensing value range rapidly fluctuates, and thus it is inconvenient for the workers to newly set quality determination standard whenever an event occurs.

For example, when there are 52 welded portions per product and when there are a total of nine production lines, since there are a need to monitor the quality control standard for 468 (52*9) welded portions, there is a situation where a lot of man-hours are required to maintain the quality inspection system.

In addition, in terms of mass production quality, when the quality determination standard is set through the upper limit value and the lower limit value based on the normal welding, there is a problem in that the defect detection ability is lowered.

In general, in the mass production sites, minute defects (small pores, etc.) that do not have a fatal effect on product functions are regarded as normally welded. These minute defects are sporadically generated over the entire welding section, and inevitably appear as abnormal waveforms on the plasma sensing value.

Accordingly, it is necessary to present the quality determination criterion by differently recognizing abnormal waveforms (abnormal waveforms caused by minute defects) generated in normal products and abnormal waveforms (abnormal waveforms caused by actual defects) generated in defective products, but when the sensing value exceeds the reference waveform by how much, there is a problem in that it is not possible to provide a consistent criterion for actual welding defects (abnormal waveform caused by actual defect).

Korean Patent Publication No. 10-1837018 (“Quality Inspection Apparatus of Laser-Welding, and Method Thereof”) discloses a technology capable of checking the quality of welding by checking a bead depth between laser welding using a confocal type sensor.

### SUMMARY

An embodiment of the present disclosure is directed to providing a system and method for checking quality of laser welding capable of performing learning processing on radiation plasma data generated during a laser welding process by using a machine learning-based network and providing consistent quality inspection results in consideration of welding process environment trends reflected in the radiation plasma data and a welding process pattern determined to be normal.

In one general aspect, a system for checking quality of laser welding includes a data input unit configured to receive new radiation data generated during a laser welding process, an input data preprocessing unit configured to preprocess the new radiation data received by the data input unit, and a quality determination unit configured to: input the new radiation data preprocessed by the input data preprocessing unit to a training model that has been learned and stored in advance, receive an anomaly score, compare the anomaly score output based on a welding location of the corresponding new radiation data based on preset anomaly conditions for each welding location, and determine whether the laser welding process in which the corresponding new radiation data is generated is normal or defective.

The system may further include, to store the training model in advance, a data collection unit configured to collect radiation data generated during the laser welding process received in advance, a collected data preprocessing unit configured to perform the preprocessing on the radiation data collected by the data collection unit, and a learning processing unit configured to perform learning processing by inputting the radiation data preprocessed by the collected data preprocessing unit to a pre-stored machine learning network, in which, in the quality determination unit, the training model by the learning processing unit may be stored.

The system may further include, to set outlier conditions for each welding location in advance, a defect extraction unit configured to extract defective radiation data, which is radiation data by a welding process determined to be defective, from among the radiation data by the data collection unit, a defective anomaly derivation unit configured to: analyze the defective radiation data extracted by the defect extraction unit, classify the defective radiation data for each welding location information based on welding location information included in each defective radiation data, input the defective radiation data for each welding location information to the training model by the learning processing unit, and derive the anomaly scores for each welding location information, and a threshold setting unit configured to use the anomaly scores for each welding location information derived by the defective anomaly derivation unit to set a threshold condition for determining whether the laser welding process is normal or defective.

The collected data preprocessing unit may include a normal extraction unit configured to extract normal radiation data, which is radiation data by a welding process determined to be normal, from among the radiation data by the data collection unit, a clustering unit configured to perform clustering of the normal radiation data by the normal extraction unit using a pre-stored algorithm, a cluster optimization unit configured to evaluate clustering by the clustering unit using the pre-stored algorithm and select the most optimal number of clusters, a centroid setting unit configured to classify the normal radiation data extracted by the normal extraction unit based on the most optimal number of clusters selected by the cluster optimization unit and set centroids of each cluster, and a learning normalization unit configured to analyze the normal radiation data included in each cluster and delete the normal radiation data corresponding to the centroid to perform data normalization.

The threshold setting unit may include an anomaly determination unit configured to determine whether the anomaly score derived by the defective anomaly derivation unit satisfies a preset over-detection rate setting condition, a threshold determination unit configured to, based on the determination result of the anomaly determination unit and when the anomaly score derived by the defective anomaly derivation unit satisfies the preset over-detection rate setting condition, determine whether a predetermined condition is satisfied based on preset thresholds for each welding location information, and a threshold update unit configured to, based on a determination result of the threshold determination unit and when the predetermined condition is satisfied, update threshold setting to the corresponding anomaly score, and may perform an operation on all the defective radiation data extracted by the defect extraction unit.

The quality determination unit may be configured to compare the anomaly score, which is an analysis result, based on the threshold setting updated by the threshold determination unit or an initial threshold, and determine that a defect has occurred in the corresponding laser welding process when the anomaly score exceeds a reference.

The input data preprocessing unit may include a similarity processing unit configured to calculate a vector similarity between the centroids of each cluster set by the centroid setting unit and the new radiation data, and search for a centroid having a highest similarity, a case addition unit configured to add new radiation data corresponding to a cluster having the centroid having the highest similarity by the similarity processing unit, a centroid resetting unit configured to reset and update the centroid of the cluster to which the new radiation data is added by the case addition unit, and an input normalization unit configured to analyze the radiation data included in each cluster and delete data corresponding to the centroid to perform the normalization of the new radiation data.

When a number of radiation data included in the cluster having the centroid having the highest similarity by the similarity processing unit exceeds a preset maximum value, the case addition unit may be configured to delete first received radiation data and adds the corresponding new radiation data.

In another general aspect, a method of checking quality of laser welding using a system for checking quality of laser welding in which each step is performed by arithmetic processing means includes, in an inference process, a data inputting step including receiving, by a data input unit, new radiation data generated during a laser welding process, an input data preprocessing step including preprocessing, by an input data preprocessing unit, the new radiation data received by the data input unit, and a quality determining step including inputting, by a quality determination unit, the new radiation data preprocessed by the input data preprocessing unit to a training model that has been learned and stored in advance, receiving an anomaly score, comparing the anomaly score output based on a welding location of the corresponding new radiation data based on preset anomaly conditions for each welding location, and determining whether the laser welding process in which the corresponding new radiation data is generated is normal or defective.

The method may further include a learning process to store the training model in advance including, a data collecting step including collecting, by a data collection unit, radiation data generated during the laser welding process received in advance, a collected data preprocessing step including performing, by a collected data preprocessing unit, preprocessing the radiation data collected by the data collection unit, and a learning processing step including performing, by a learning processing unit, learning processing by inputting the radiation data preprocessed by the collected data preprocessing unit to a pre-stored machine learning network may be further performed,

To set the anomaly conditions for each welding location in advance, in the learning process, a defect extracting step including extracting, by a defect extraction unit, defective radiation data, which is radiation data by a welding process determined to be defective, from among the radiation data by the data collection unit, a defective anomaly deriving step including analyzing, by a defective anomaly derivation unit, the defective radiation data extracted by the defect extraction unit, classifying the defective radiation data for each welding location information based on welding location information included in each defective radiation data, inputting the defective radiation data for each welding location information to the training model in the learning processing step, and deriving the anomaly scores for each welding location information, and an anomaly determining step including determining, by an anomaly determination unit, whether the anomaly score derived by the defective anomaly derivation unit satisfies a preset over-detection rate setting condition, based on the determination result of the anomaly determining step, and in response to the anomaly score derived by the defective anomaly derivation unit satisfying the preset over-detection rate setting condition, a threshold determining step including determining, by a threshold determination unit, whether a predetermined condition is satisfied based on preset thresholds for each welding location information threshold, and based on a determination result of the threshold determining step, and in response to the predetermined condition being satisfied, a threshold updating step including updating, by a threshold update unit, threshold setting to the corresponding anomaly score may be further performed.

The quality determining step may include comparing, by the quality determination unit, the anomaly score, which is an analysis result, based on the threshold setting updated by the threshold update unit or an initial threshold, and determining that a defect has occurred in the corresponding laser welding process in response to the anomaly score exceeding a reference.

The collected data preprocessing step may include a normal extracting step including extracting, by a normal extraction unit, normal radiation data, which is radiation data by a welding process determined to be normal, from among the radiation data by the data collection unit, a clustering step including performing, by a clustering unit, clustering of the normal radiation data by the normal extraction unit using a pre-stored algorithm, a cluster optimization step including evaluating, by a cluster optimization unit, the clustering by the clustering unit using the pre-stored algorithm and selecting the most optimal number of clusters, a centroid setting step including classifying, by a centroid setting unit, the normal radiation data extracted by the normal extraction unit based on the most optimal number of clusters selected by the cluster optimization unit, and setting a centroid of each cluster, and a learning normalization step including analyzing, by a learning normalization unit, the normal radiation data included in each cluster and deleting the normal radiation data corresponding to the centroid to perform data normalization.

The input data preprocessing step may include a similarity processing step including calculating, by a similarity processing unit, a vector similarity between the centroids of each cluster set by the centroid setting unit and the new radiation data, and searching for a centroid having a highest similarity, a case adding step including adding, by a case addition unit, new radiation data corresponding to a cluster having a centroid having the highest similarity by the similarity processing unit, a centroid resetting unit of resetting and updating, both by a centroid resetting unit, the centroid of the cluster to which the new radiation data is added by the case addition unit, and an input normalization step including analyzing, by an input normalization unit, the radiation data included in each cluster and deleting data corresponding to the centroid to perform the normalization of the new radiation data.

In response to the number of radiation data included in the cluster having the centroid having the highest similarity by the similarity processing unit exceeding a preset maximum value, the case adding step may include deleting, by the case addition unit, first received radiation data and adding the corresponding new radiation data.

### BRIEF DESCRIPTION OF THE DRAWINGS

FIG. 1 is an exemplary configuration diagram illustrating a system for checking quality of laser welding according to an embodiment of the present disclosure.

FIG. 2 is an exemplary flowchart illustrating a method of checking quality of laser welding according to an embodiment of the present disclosure.

### DETAILED DESCRIPTION OF EMBODIMENTS

The above-described objects, features, and advantages of the present disclosure will become more obvious from the following detailed description provided in relation to the accompanying drawings. The following specific structural or functional descriptions are only exemplified for the purpose of explaining the embodiments according to the concept of the present disclosure, and the embodiments according to the concept of the present disclosure may be implemented in various forms and should not be construed as limited to the embodiments described herein or in the application. Since embodiments according to the concept of the present disclosure may be variously modified and may have several forms, specific embodiments will be illustrated in the accompanying drawings and will be described in detail in the present specification or application. However, it is to be understood that the present disclosure is not limited to specific embodiments, but includes all modifications, equivalents, and substitutions falling in the spirit and the scope of the present disclosure. Terms such as first, second, or the like, may be used to describe various components, but these components are not to be construed as being limited to these terms. The terms are used only to distinguish one component from another component. For example, a first component may be named a second component and the second component may also be named the first component, without departing from the scope of the present disclosure. It is to be understood that when one component is referred to as being connected to or coupled to another component, it may be connected directly to or coupled directly to another component or be connected to or coupled to another component with the other component interposed therebetween. On the other hand, it is to be understood that when one component is referred to as being connected directly to or coupled directly to another component, it may be connected to or coupled to another component without the other component interposed therebetween. Other expressions describing a relationship between components, that is, “between,” “˜directly between,” “˜neighboring to,” “˜directly neighboring to,” and the like, should be similarly interpreted. Terms used in the present specification are used only in order to describe specific embodiments rather than limiting the present disclosure. Singular forms are intended to include plural forms unless the context clearly indicates otherwise. It is to be understood that terms “include,” “have,” or the like, used in the present specification specify the presence of features, numerals, steps, operations, components, parts, or a combination thereof described in the present specification, but do not preclude the presence or addition of one or more other features, numerals, steps, operations, components, parts, or a combination thereof. Unless indicated otherwise, it is to be understood that all the terms used in the specification including technical and scientific terms have the same meaning as those that are generally understood by those who skilled in the art. Terms generally used and defined in a dictionary are to be interpreted as the same meanings with meanings within the context of the related art, and are not to be interpreted as ideal or excessively formal meanings unless clearly indicated in the present specification. Hereinafter, embodiments of the present disclosure will be described in detail with reference to the accompanying drawings. Like reference numerals proposed in each drawing denote like components.

In addition, a system means a set of components including devices, mechanisms, means, and the like, systematized in order to perform required functions and regularly interacting with one another.

A system and method for checking quality of laser welding according to an embodiment of the present disclosure is largely divided into a learning process and an inference process.

The learning process is a process for generating a training model (baseline model) that may determine whether the laser welding quality is normal or defective, and uses welding plasma data collected in advance.

The inference process is a process for determining normal/defect for newly input welding plasma data using the generated training model.

In this case, in the present disclosure, by continuously performing the learning process using the welding plasma data determined to be normal in the inference process, the training model is updated, resulting in quality inspection results having increasingly higher accuracy and reliability.

In view of this point, a system and method for checking quality of laser welding according to an embodiment of the present disclosure will be described in detail.

The system and method for checking quality of laser welding of the present disclosure may apply a consistent defect determination criterion for laser welding quality by applying an anomaly score that is inferred based on machine learning. That is, the anomaly score is assigned to determine the degree of deviation of the input data (new data) compared to a normal data distribution trained by the training model, and when the anomaly score is greater than a threshold of past defective products, the product according to the corresponding welding process is determined to be defective.

Compared to variables (upper limit and lower limit height, invasion frequency, invasion area, etc., based on a reference sensing value) that have been applied as conventional defect determination criteria, comparison variables may be reduced to one dimension called an anomaly score, so there is the advantage that a worker does not have to continuously adjust the quality determination criterion.

In addition, by extracting and deleting process environment trends during a data preprocessing process, it is possible to minimize the influence on the process environment trend.

It is possible to not only delete the process environment trends, but also continuously monitor the deleted process environment trends and use the process environment trends to improve the process environment.

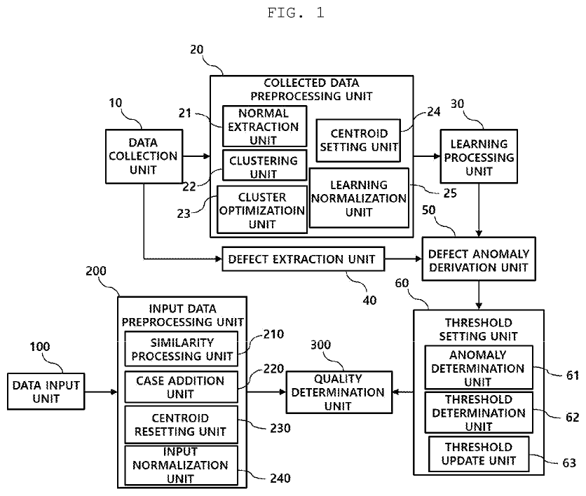

FIG. 1 illustrates a configuration diagram illustrating a system for checking quality of laser welding according to an embodiment of the present disclosure.

As illustrated in FIG. 1, the system for checking quality of laser welding according to an embodiment of the present disclosure preferably includes a data collection unit 10, a collected data preprocessing unit 20, a learning processing unit 30, a defect extraction unit 40, a defective anomaly derivation unit 50, and a threshold setting unit 60 that perform an operation in a learning process, and a data input unit 100, an input data preprocessing unit 200, and quality determination unit 300 that perform an operation in an inference process.

As described above, since the results of the inference process are continuously and successively reflected in the learning process, it is preferable that each component performs an operation through arithmetic processing means including a computer.

Although there is a difference in drawing numbers between the configuration that performs operations in the learning process and the configuration that performs operations in the inference process, this is only a description for smooth explanation, and considering this, the arithmetic processing means do not necessarily have to be separated.

Each component will be described in detail.

The data collection unit 10 preferably collects radiation data generated during the laser welding process that has been received in advance, that is, collected in advance.

Here, the radiation data means a plasma sensing value, and the acquisition process is generated by converting a process wave (plasma) radiated from a welded portion in a welding process into an optical signal (near infrared ray, near ultraviolet ray).

The collected data preprocessing unit 20 preferably performs preprocessing on radiation data collected by the data collection unit 10.

The collected data preprocessing unit 20 removes a process environment trend in units of milliseconds (ms) and performs time-series data processing capable of preserving only the amount of change (noise) of the optical signal (radiation data). When a quality determination criterion is set through the upper and lower limit values based on normal welding in terms of mass production quality, which is a problem in the related art, the operation of the collected data pre-processing unit 20 is to solve the problem that even abnormal waveforms (abnormal waveforms due to minute defects) generated in a number of normal products have a pattern that exceeds the quality criterion and are determined to be defective.

To this end, as illustrated in FIG. 1, the collected data preprocessing unit 20 includes a normal extraction unit 21, a clustering unit 22, a cluster optimization unit 23, a centroid setting unit 24, and a learning normalization unit 25.

The normal extraction unit 21 preferably extracts normal radiation data, which is radiation data by a welding process determined to be normal, from among the radiation data by the data collection unit. That is, only data in which welding has been normally performed among all data is extracted.

Since the data collection unit 10 is radiation data collected in advance, welding normal or welding defect information, which is a result of an existing welding process, is naturally labeled.

The normal extraction unit 21 considers this and extracts only normal radiation data.

The clustering unit 22 preferably performs clustering of the normal radiation data by the normal extraction unit 21 using a pre-stored algorithm.

In detail, the clustering unit 22 performs the clustering of the normal radiation data by the normal extraction unit 21, that is, waveform clustering, using a K-means algorithm. By removing the process environment trend, the height of the waveform that varies by welding location (bead) and period may be corrected to zero.

In this way, it is possible to classify normal mass-produced quality standard products according to characteristics, so noise occurring in common, that is, noise caused by the process environment trend, may be removed.

To briefly explain the K-means algorithm, assuming that any data set exists and is classified into k clusters, there are k centroids in the data set. Each data is assigned to a nearby centroid based on a Euclidean distance, and a group of data gathered at the same centroid becomes one cluster.

Considering this, the clustering unit 22 performs the clustering of the normal radiation data by the normal extraction unit 21 while varying k from 2 to 10.

It is preferable that the cluster optimization unit 23 evaluates clustering by the clustering unit 22 using a pre-stored algorithm and selects the most optimal number of clusters.

In detail, the cluster optimization unit 23 evaluates clustering by the clustering unit 22 based on a silhouette coefficient, which is a cluster evaluation index, and selects the final k, which is the most optimal number of clusters.

In this case, the silhouette coefficient is obtained by calculating a distance between each data point and surrounding data points, and is used as a criterion for evaluating clustering whether the data in the cluster are well gathered and whether the clusters are well distinguished from each other.

The centroid setting unit 24 classifies the normal radiation data extracted by the normal extraction unit 21 based on the most optimal number of clusters selected by the cluster optimization unit 23.

In this way, each centroid is set for each cluster. That is, k centroids are set.

The learning normalization unit 25 preferably analyzes the normal radiation data included in each cluster and deletes the normal radiation data corresponding to the centroid to perform data normalization.

That is, when the normal radiation data extracted by the normal extraction unit 21 is classified based on the most optimal number of clusters selected by the cluster optimization unit 23, each normal radiation data is classified by being assigned to a close centroid based on the Euclidean distance.

In other words, the normal radiation data is grouped by characteristics (by welding location (bead), by period, etc.) of the laser welding process.

In consideration of this, the learning normalization unit 25 performs data normalization by setting commonly generated noise for each group as the process environment trend and removing the noise.

The operation of the collected data preprocessing unit 20 considers the characteristics of the plasma sensing value that changes on a daily basis, performs the operation on a daily basis, and performs operations on all days collected by the data collection unit 10.

The learning processing unit 30 preferably performs learning processing by inputting the radiation data preprocessed by the collected data preprocessing unit 20 to a pre-stored machine learning network.

In detail, the learning processing unit 30 generates training data by merging operation performance results on a daily basis through the collected data preprocessing unit 20.

The learning processing is performed by inputting the generated training data to the pre-stored machine learning network.

As the pre-stored machine learning network, a one-dimensional convolutional neural network (1D-CNN) algorithm is used, but this is only one embodiment of the present disclosure, and is not necessarily limited thereto.

However, as the pre-stored machine learning network in the learning processing unit 30, the learning processing is performed to extract characteristics of each welding section using the 1D-CNN algorithm.

For the configuration of the 1D-CNN algorithm, for example, an encoder including three layers, a decoder including three layers, and ReLu as an activation function are configured, and a kernel size is set to be 30, a stride is set to be 2, and a mean squared error (MSE) is set as a loss function.

In the present disclosure, by using the training model, which is the learning result of the learning processing unit 30 and using the output anomaly score, it is determined whether the laser welding process is normal or defective. As described above, since a normal product may be determined to be defective depending on how to set the quality determination criterion based on the reference sensing value, it is preferable to consider the optimal setting of the threshold, which is the determination criterion.

To this end, the defect extraction unit 40 preferably extracts defective radiation data, which is radiation data by a welding process determined to be defective, from among the radiation data by the data collection unit 10. That is, only data in which welding has been performed due to defects among all data is extracted.

It is preferable that the defective anomaly derivation unit 50 analyzes the defective radiation data extracted by the defect extraction unit 40 and classifies the defective radiation data for each welding location information based on the welding location information included in each defective radiation data.

This can be performed through information labeled in the radiation data.

Thereafter, it is preferable to derive anomaly scores for each welding location information by inputting the defective radiation data for each welding location information to the training model by the learning processing unit 30.

The threshold setting unit 60 preferably uses the anomaly scores for each welding location information derived by the defective anomaly derivation unit 50 to set a threshold condition for determining whether the laser welding process is normal or defective.

To this end, as illustrated in FIG. 1, the threshold setting unit 60 includes an anomaly determination unit 61, a threshold determination unit 62, and a threshold update unit 63.

The anomaly determination unit 61 preferably determines whether the anomaly score derived by the defective anomaly derivation unit 50 corresponding to certain specific welding location information satisfies a preset over-detection rate setting condition.

In detail, the anomaly determination unit 61 preferably determines whether the anomaly score derived by the defective anomaly derivation unit 50 satisfies anomaly score having 1% of an over-detection rate (rate of determining normal as defective) which is a preset over-detection rate setting condition<anomaly score derived by the defective anomaly derivation unit 50<1 (initial threshold).

In this case, since “1” is an initial threshold, it is safe to say that there is no threshold.

As the determination result of the anomaly determination unit 61, when the anomaly score derived by the defective anomaly derivation unit 50 satisfies the preset over-detection rate setting condition, in other words, the anomaly score derived by the defective anomaly derivation unit 50 is less than the initial threshold while exceeding the anomaly score of 1% of the over-detection rate (rate of determining normal as defective), it is preferable that the threshold determination unit 62 additionally determines whether the anomaly score derived by the defective anomaly derivation unit 50 satisfies a predetermined condition based on the thresholds for each welding location information set.

That is, the threshold determination unit 62 determines whether the anomaly score derived by the defective anomaly derivation unit 50 is less than the thresholds for each welding location information which is the predetermined condition.

Here, the threshold sets for each welding location information are set differently according to the operation of the threshold update unit 63 to be described later.

That is, since the threshold is set to “1,” which is the initial threshold, during the initial operation of the threshold determination unit 62, it is determined whether the anomaly score corresponding to certain specific welding location information derived by the defective anomaly derivation unit 50 is less than the initial threshold set in the corresponding welding location information.

Subsequently, as the determination result of the threshold determination unit 62, when anomaly score derived by the defective anomaly derivation unit 50 is less than the set threshold of the corresponding welding location information, it is preferable that the threshold update unit 63 updates the threshold setting of the corresponding welding location to the anomaly score derived by the defective anomaly derivation unit 50 which is the corresponding anomaly score.

That is, as the initial operation result of the threshold determination unit 62, when the anomaly score corresponding to certain specific welding location information derived by the defective anomaly derivation unit 50 is less than the initial threshold set in the corresponding welding location information, the threshold for the corresponding welding location information is updated to the anomaly score corresponding to certain specific welding location information derived by the defective anomaly derivation unit 50.

Since the threshold setting unit 60 is set to operate on all the defective radiation data extracted by the defect extraction unit 40, the thresholds set for each welding location information vary according to repeated execution.

Through the process of the threshold setting unit 60, it is possible to exclude a defective label close to a normal waveform (normal radiation data) from among the defective radiation data.

In addition, as a result of performing the operation on all the defective radiation data extracted by the defect extraction unit 40, when there is no satisfactory defective radiation data in the determination result of the anomaly determination unit 61 and the determination result of the threshold determination unit 62, the thresholds set for each welding location information correspond to the initial threshold.

As such, after the operations of the data collection unit 10, the collected data preprocessing unit 20, the learning processing unit 30, the defect extraction unit 40, the defective anomaly derivation unit 50, and the threshold setting unit 60 are completed, through the data input unit 100, the input data preprocessing unit 200, and the quality determination unit 300, it is determined whether the corresponding laser welding process is normal or defective using the radiation data generated in the actual laser welding process.

It is preferable that the data input unit 100 newly receives the radiation data generated in the laser welding process, that is, receives new radiation data.

The input data preprocessing unit 200 preferably performs preprocessing on new radiation data input by the data input unit 100.

Like the learning process, the inference process also removes noise caused by a process environment trend of new radiation data.

To this end, as illustrated in FIG. 1, it is preferable that the input data preprocessing unit 200 further includes a similarity processing unit 210, a case addition unit 220, a centroid resetting unit 230, and an input normalization unit 240.

The input data preprocessing unit 200 uses a real time moving average clustering algorithm to estimate the process environment trend for new training data in order to perform the same preprocessing operation as the training data.

However, when the clustering is performed every time new radiation data is input, calculation complexity increases, which may affect real-time defect determination, and all data should be stored, which may continue to increase memory usage.

Therefore, the input data preprocessing unit 200 may use a real-time moving average clustering algorithm to update only the centroid of the cluster to which the new input data belongs to reduce computational complexity, and remove the oldest data of the corresponding cluster to keep the memory size constant.

In detail, the similarity processing unit 210 preferably calculates a vector similarity between the centroids of each cluster set by the centroid setting unit 24 and searches for a centroid having a highest similarity. This calculates the vector similarity based on the Euclidean distance. The criterion for the vector similarity is set to ≤1.

The case addition unit 220 preferably adds new radiation data corresponding to a cluster having the centroid having the highest similarity by the similarity processing unit 210.

In this case, when the number of radiation data included in the cluster having the centroid having the highest similarity by the similarity processing unit 210 exceeds a preset maximum value, it is preferable that the case addition unit 220 deletes first received radiation data and adds the corresponding new radiation data.

Of course, when the number of radiation data included in the cluster having the highest centroid by the similarity processing unit 210 is less than the preset maximum value, it is preferable to add new radiation data without deleting the existing radiation data included in the corresponding cluster.

As described above, the centroid resetting unit 230 preferably resets and updates the centroid of the cluster to which new radiation data is added by the case addition unit 220 in order to update only the centroid of the cluster to which the new input data belongs.

The centroid of the cluster is naturally set using the Euclidean distance between the radiation data included in the cluster.

It is preferable that the input normalization unit 240 analyzes radiation data (normal radiation data classified by the centroid setting unit 24+new radiation data by the data input unit 100) included in each cluster, deletes data corresponding to the centroid, and performs the normalization of new radiation data.

That is, the data normalization is performed by setting noise commonly occurring in a group including new radiation data as a process environment trend and removing the noise.

As the search result of the similarity processing unit 210, when the centroid that meets the new radiation data and criterion is not searched, it is preferable that the input data preprocessing unit 200 newly performs clustering on the new radiation data by using the K-means algorithm together with the normal radiation data extracted by the normal extraction unit 21.

As the search result of the similarity processing unit 210, when the centroid that meets the new radiation data and criterion is not searched, it is predicted that the process environment changes greatly, and assuming that vector similarity>1, it is preferable to newly perform the clustering using the K-means algorithm.

Thereafter, the centroid is set for each new cluster, the data corresponding to the centroid is deleted, and data included in each cluster is normalized.

The quality determination unit 300 performs the preprocessing by the input data preprocessing unit 200 on the training model by the learning processing unit 30. In other words, the quality determination unit 300 inputs normalized new radiation data to receive an anomaly score, which is an analysis result of the corresponding new radiation data.

In this case, the normalized new radiation data means that the data corresponding to the centroid is deleted in consideration of the included cluster.

It is preferable that the quality determination unit 300 compares the anomaly score, which is the analysis result, based on the threshold condition set by the threshold setting unit 60 to determine whether the corresponding laser welding process is normal or defective. In this case, the comparison process of the anomaly score is compared with the anomaly condition set based on the welding location of the new radiation data, and it is determined whether the laser welding process in which the corresponding new radiation data is generated is normal or defective.

In other words, it is preferable that the quality determination unit 300 compares the anomaly score, which is the analysis result of the corresponding new radiation data, based on the threshold setting updated by the threshold update unit 63 or the initial threshold based on the welding location of the new radiation data, and when the anomaly score exceeds the reference, determines that a defect has occurred in the laser welding process that generates the corresponding new radiation data.

In addition, as the determination result of the quality determination unit 300, when the laser welding process that generates the corresponding new radiation data is determined to be normal, the system for checking quality of laser welding according to an embodiment of the present disclosure preferably updates the training model by adding the corresponding new radiation data to the training data set.

Of course, the process preferably performs additional learning by utilizing factory downtime when the laser welding process is not in progress.

That is, the operation of the clustering unit 22 is repeatedly performed using the corresponding new radiation data.

In addition, as the determination result of the quality determination unit 300, when the laser welding process that generates the corresponding new radiation data is determined to be defective, it is preferable to repeatedly perform threshold optimization using the corresponding new radiation data.

That is, the operation of the defective anomaly derivation unit 50 is repeatedly performed using the corresponding new radiation data.

In this case, in consideration of the performance of the arithmetic processing means available in the mass production application process, the time available for learning, the amount of available memory, etc., the operation is repeatedly performed while deleting the past radiation data. As for the deletion condition, it is preferable to delete the radiation data that is input most recently.

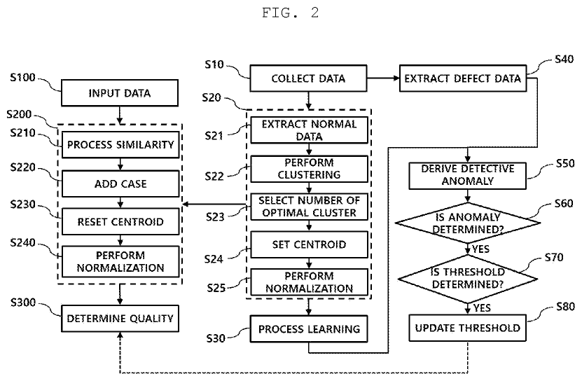

FIG. 2 illustrates a flowchart of a method of checking quality of laser welding according to an embodiment of the present disclosure.

As illustrated in FIG. 2, the method of checking quality of laser welding according to an embodiment of the present disclosure includes a data collecting step S10 corresponding to the learning process, a collected data preprocessing step S20, a learning processing step S30, a defect extracting step S40, a defective anomaly deriving step S50, an anomaly determining step S60, a threshold determining step S70, a threshold updating step S80, a data inputting step S100 corresponding to the inference process, an input data preprocessing step S200, and a quality determining step S300.

Each step preferably uses the system for checking quality of laser welding performed by the arithmetic processing means.

In the method of checking quality of laser welding according to an embodiment of the present disclosure, the results of the inference process are continuously and successively reflected in the learning process, which will be described later in detail.

Each step will be described in detail.

In the data collecting step S10, the data collection unit 10 collects the radiation data generated in the laser welding process that has been received in advance, that is, collected in advance.

Here, the radiation data means a plasma sensing value, and the acquisition process is generated by converting a process wave (plasma) radiated from a welded portion in a welding process into an optical signal (near infrared ray, near ultraviolet ray). In addition, welding normality, welding defect information, welding location information, etc., which are results of the welding process for each radiation data, are labeled.

In the collected data preprocessing step S20, the collected data preprocessing unit 20 performs the preprocessing on the radiation data collected by the data collecting step S10.

In the collected data preprocessing step S20, the process environment trend is removed in units of milliseconds (ms) and time-series data processing capable of preserving only the amount of change (noise) of the optical signal (radiation data) is performed. When a quality determination criterion is set through the upper and lower limit values based on normal welding in terms of mass production quality, which is a problem in the related art, the operation of the collected data preprocessing step S20 is to solve the problem that even abnormal waveforms (abnormal waveforms due to minute defect) occurring in a number of normal products has a pattern that exceeds the quality determination criterion and are determined to be defective.

As illustrated in FIG. 2, the collected data preprocessing step S20 includes a normal extracting step S21, a clustering step S22, a cluster optimization step S23, a centroid setting step S24, and a learning normalization step S25.

In the collected data preprocessing step S20, the operation is performed on a daily basis in consideration of the characteristics of the plasma sensing values that change on a daily basis, and the operations are performed for all days collected by the data collecting step S10.

In the normal extracting step S21, the normal radiation data, which is the radiation data by the welding process determined to be normal, is extracted from among the radiation data by the data collecting step S10. That is, only data in which welding has been normally performed among all data is extracted.

In the clustering step S22, the clustering of the normal radiation data by the normal extracting step S21 is preferably performed using the pre-stored algorithm.

Using the K-means algorithm as the pre-stored algorithm, the clustering of the normal radiation data, that is, the waveform clustering by the normal extracting step S21 is performed. By removing the process environment trend, the height of the waveform that varies by welding location (bead) and period may be corrected to zero.

In this way, it is possible to classify normal mass-produced quality standard products according to characteristics, so noise occurring in common, that is, noise caused by the process environment trend, may be removed.

To briefly explain the K-means algorithm, assuming that any data set exists and is classified into k clusters, there are k centroids in the data set. Each data is assigned to a nearby centroid based on a Euclidean distance, and a group of data gathered at the same centroid becomes one cluster.

Considering this, in the clustering step S22, the clustering of the normal radiation data by the normal extracting step S21 is performed while k varies from 2 to 10.

In the cluster optimization step S23, the clustering by the clustering step S22 is evaluated using the pre-stored algorithm and the most optimal number of clusters is selected.

As the pre-stored algorithm, a silhouette coefficient, which is a cluster evaluation index, is used. Based on the silhouette coefficient, the clustering is evaluated in the clustering step S22, and the final k, which is the most optimal number of clusters, is selected.

In this case, the silhouette coefficient is obtained by calculating a distance between each data point and surrounding data points, and is used as a criterion for evaluating clustering whether the data in the cluster are well gathered and whether the clusters are well distinguished from each other.

The centroid setting step S24 classifies the normal radiation data extracted by the normal extracting step S21 based on the most optimal number of clusters selected by the cluster optimization step S23. In this way, each centroid is set for each cluster. That is, k centroids are set.

In the learning normalization step S25, the normal radiation data included in each cluster is analyzed and the normal radiation data corresponding to the centroid is deleted, thereby performing the data normalization.

That is, when the normal radiation data extracted by the normal extracting step S21 is classified based on the most optimal number of clusters selected by the cluster optimization step S23, each normal radiation data is classified by being assigned to a close centroid based on the Euclidean distance.

In other words, the normal radiation data is grouped by characteristics (by welding location (bead), by period, etc.) of the laser welding process.

In consideration of this, in the learning normalization step S25, the commonly generated noise for each group is set as the process environment trend and the noise is removed, thereby performing the data normalization.

In the learning processing step S30, the learning processing unit 30 inputs the radiation data preprocessed by the collected data preprocessing step S20 to the pre-stored machine learning network to perform the learning processing.

In detail, in the learning processing step S30, the operation performance results on a daily basis by the collected data preprocessing step S20 are merged and generated as the training data. The learning processing is performed by inputting the generated training data to the pre-stored machine learning network.

As the pre-stored machine learning network, a 1D-CNN algorithm is used, but this is only one embodiment of the present disclosure, and is not necessarily limited thereto.

In the learning processing step S30, the learning processing is performed to extract characteristics of each welding section using the pre-stored machine learning network.

For the configuration of the 1D-CNN algorithm, for example, an encoder including three layers, a decoder including three layers, and ReLu as an activation function are configured, and a kernel size is set to be 30, a stride is set to be 2, and a mean squared error (MSE) is set as a loss function.

Most ideally, by using the training model, which is the learning result of the learning processing step S30 and using the output anomaly score, it is to determine whether the laser welding process is normal or defective. However, as described above, since a normal product may be determined to be defective depending on how to set the quality determination criterion based on the reference sensing value, it is preferable to consider the optimal setting of the threshold, which is the determination criterion.

To this end, in the defect extracting step S40, the defect extraction unit 40 extracts the defective radiation data, which is the radiation data by the welding process determined to be defective, from among the radiation data in the data collecting step S10. That is, only data in which welding has been performed due to defects among all data is extracted.

In the defective anomaly deriving step S50, the defective anomaly derivation unit 50 analyzes the defective radiation data extracted by the defect extracting step S40, classifies the defective radiation data for each welding location information based on welding location information included in each defective radiation data, inputs the defective radiation data for each welding location information to the training model by the learning processing step S30, and derives the anomaly scores for each welding location information.

In other words, in the defective anomaly deriving step S50, the extracted defective radiation data is analyzed, and each welding location information based on the welding location information included in each defective radiation data is classified, which is performed through information labeled in the radiation data.

Thereafter, the defective radiation data for each welding location information is input to the training model, and an anomaly score for each welding location information is derived.

In the anomaly determining step S60, the anomaly determination unit 61 determines whether the anomaly score derived by the defective anomaly deriving step S50 satisfies a preset over-detection rate setting condition.

In this case, the meaning of the anomaly score derived by the defective anomaly deriving step S50 is an anomaly score derived by defective radiation data corresponding to certain specific welding location information.

In the anomaly determining step S60, it is determined whether the anomaly score derived by the defective anomaly deriving step S50 satisfies anomaly score having 1% of an over-detection rate (rate of determining normal as defective) which is a preset over-detection rate setting condition<anomaly score derived by the defective anomaly derivation unit 50<1 (initial threshold).

In this case, since “1” is an initial threshold, it is safe to say that there is no threshold.

In the threshold determining step S70, as the determination result of the anomaly determining step S60, when the anomaly score derived by the defective anomaly deriving step S50 satisfies the preset over-detection rate setting condition, in other words, the anomaly score derived by the defective anomaly deriving step S50 is less than the initial threshold while exceeding the anomaly score of 1% of the over-detection rate (rate of determining normal as defective), the threshold determination unit 62 additionally determines whether the anomaly score derived by the defective anomaly deriving step S50 satisfies a predetermined condition based on the thresholds for each welding location information set.

That is, in the threshold determining step S70, it is determined whether the anomaly score derived by the defective anomaly deriving step S50 is less than the thresholds for each welding location information which is the predetermined condition.

Here, the thresholds set for each welding location information are naturally set as the initial threshold when the first operation is performed, but may be set differently as the defective anomaly deriving step S50, the anomaly determining step S60, the threshold determining step S70, and the threshold updating step S80 to be described later are performed using the defective radiation data extracted by the defect extracting step S40.

In other words, since the threshold is set to “1,” which is the initial threshold, during the initial operation of the threshold determining step S70, it is determined whether the anomaly score corresponding to certain specific welding location information derived by the defective anomaly deriving step S50 is less than the initial threshold set in the corresponding welding location information.

In the threshold updating step S80, as the determination result of the threshold determining step S70, when the anomaly score derived by the defective anomaly deriving step S50 is less than the set threshold of the corresponding welding location information, the threshold update unit 63 updates the threshold setting of the corresponding welding location to the anomaly score derived by the defective anomaly deriving step S50 which is the corresponding anomaly score.

That is, as the initial operation result of the threshold determining step S70, when the anomaly score corresponding to certain specific welding location information derived by the defective anomaly deriving step S50 is less than the initial threshold set in the corresponding welding location information, the threshold for the corresponding welding location information is updated to the anomaly score corresponding to certain specific welding location information derived by the defective anomaly deriving step S50.

Since the defective anomaly deriving step S50, the anomaly determining step S60, the threshold determining step S70, and the threshold updating step S80 are set to perform operations on all defective radiation data extracted by the defect extracting step S40, the threshold set for each welding location information varies according to repeated execution.

As the above-described defective anomaly deriving step S50, anomaly determining step S60, threshold determining step S70, and threshold updating step S80 are performed, defective labels close to normal waveforms (normal radiation data) may be excluded from among the defective radiation data.

In addition, as a result of performing the operation on all the defective radiation data, when there is no defective radiation data that satisfies the anomaly determining step S60 and the threshold determining step S70, the thresholds set for each welding location information correspond to the initial threshold.

In this way, after performing the defective anomaly deriving step S50, the anomaly determining step S60, the threshold determining step S70, and the threshold updating step S80 on all the defective radiation data extracted by the defect extracting step S40, it is determined whether the corresponding laser welding process is normal or defective by using the radiation data generated in the actual laser welding process.

In the data inputting step S100, the data input unit 100 newly receives the radiation data generated in the laser welding process, that is, receives new radiation data.

In the input data preprocessing step S200, the input data preprocessing unit 200 performs the preprocessing on the new radiation data received by the data inputting step S100.

Like the learning process, the inference process also removes noise caused by a process environment trend of new radiation data.

To this end, in the input data preprocessing step S200, a real time moving average clustering algorithm is used to estimate the process environment trend for new training data in order to perform the same preprocessing operation as the training data.

However, when the clustering is performed every time new radiation data is input, calculation complexity increases, which may affect real-time defect determination, and all data should be stored, which may continue to increase memory usage.

Therefore, in the input data preprocessing step S200, real-time moving average clustering algorithm may be used to update only the centroid of the cluster to which the new input data belongs to reduce computational complexity, and remove the oldest data of the corresponding cluster to keep the memory size constant.

As illustrated in FIG. 2, the input data preprocessing step S200 includes a similarity processing step S210, a case adding step S220, a centroid resetting step S230, and an input normalization step S240.

In the similarity processing step S210, the similarity processing unit 210 calculates the vector similarity between the centroids of each cluster set by the centroid setting step S24 and the new radiation data, and searches for the centroid having the highest similarity. This calculates the vector similarity based on the Euclidean distance. The criterion for the vector similarity is set to ≤1.

In the case adding step S220, the case addition unit 220 adds new radiation data corresponding to the cluster having the centroid having the highest similarity by the similarity processing step S210.

In this case, in the case adding step S220, when the number of radiation data included in the cluster having the centroid having the highest similarity by the similarity processing step S210 exceeds a preset maximum value, the first received radiation data is deleted and the corresponding new radiation data is added.

Alternatively, in the case adding step S220, when the number of radiation data included in the cluster having the highest centroid by the similarity processing step S210 is less than the preset maximum value, new radiation data may also be added without deleting the existing radiation data included in the corresponding cluster.

In the centroid resetting step S230, the centroid resetting unit 230 resets and updates the centroid of the cluster to which new radiation data is added by the case adding step S220 in order to update only the centroid of the cluster to which the new input data belongs.

The centroid of the cluster is naturally set using the Euclidean distance between the radiation data included in the cluster.

In the input normalization step S240, the input normalization unit 240 analyzes radiation data (normal radiation data classified by the centroid setting step S24+new radiation data by the data inputting step S100) included in each cluster, deletes data corresponding to the centroid, and performs the normalization of new radiation data.

That is, the data normalization is performed by setting noise commonly occurring in a group including new radiation data as a process environment trend and removing the noise.

As the search result of the similarity processing step S210, when the centroid that meets the new radiation data and criterion is not searched, in the input data preprocessing step S200, the clustering is newly performed by using the K-means algorithm together with the normal radiation data extracted by the normal extracting step S21.

In this way, as the search result of the similarity processing step S210, when the centroid that meets the new radiation data and criterion is not searched, it is predicted that the process environment changes greatly, and assuming that vector similarity>1, the clustering is newly performed using the K-means algorithm.

Thereafter, the centroid is set for each new cluster, the data corresponding to the centroid is deleted, and data included in each cluster is normalized.

In the quality determining step S300, the quality determination unit 300 inputs new radiation data preprocessed by the input data preprocessing step S200 to the training model by the learning processing step S30, and receives the analysis result of the corresponding new radiation data, and compares the analysis results based on the set threshold conditions to determine whether the laser welding process is normal or defective.

Here, the set threshold condition means the threshold setting updated by the threshold updating step S80 or the initial threshold.

In the quality determining step S300, the anomaly score, which is the analysis result of the corresponding new radiation data, is compared based on the set threshold condition, and when the anomaly score exceeds the reference, it is determined that the laser welding process that generates the corresponding new radiation data is defective. In this case, the comparison process of the anomaly score is compared with the anomaly condition set based on the welding location of the new radiation data, and determines whether the laser welding process in which the corresponding new radiation data is generated is normal or defective.

In this way, in other words, in the quality determining step S300, the anomaly score, which is the analysis result of the corresponding new radiation data, is compared based on the threshold setting updated by the threshold updating step S80 or the initial threshold based on the welding location of the new radiation data, and when the anomaly score exceeds the reference, it is determined that a defect has occurred in the laser welding process that generates the corresponding new radiation data.

The method of checking quality of laser welding according to an embodiment of the present disclosure not only determines whether the laser welding process is normal or defective, but also, according to the determination result by the quality determining step S300, when the laser welding process that generates the corresponding new radiation data is determined to be normal, adds the corresponding new radiation data to the training data set to update the training model.

Of course, the process performs additional learning by utilizing factory downtime when the laser welding process is not in progress. That is, the operation of clustering step S22 is repeatedly performed using the corresponding new radiation data.

In addition, as the determination result of the quality determining step S300, when the laser welding process that generates the corresponding new radiation data is determined to be defective, the threshold optimization is repeatedly performed using the corresponding new radiation data. That is, the operation of the defective anomaly deriving step S50 is repeatedly performed using the corresponding new radiation data.

In this case, in consideration of the performance of the arithmetic processing means available in the mass production application process, the time available for learning, the amount of available memory, etc., the operation is repeatedly performed while deleting the past radiation data. As for the deletion condition, it is preferable to delete the radiation data that is input most recently.

The present disclosure described above can be embodied as a computer readable code on a medium in which a program is recorded. A computer readable medium may include all kinds of recording devices in which data that may be read by a computer system are stored. An example of the computer readable medium may include a hard disk drive (HDD), a solid state disk (SSD), a silicon disk drive (SDD), a read only memory (ROM), a random access memory (RAM), a compact disk read only memory (CD-ROM), a magnetic tape, a floppy disk, an optical data storage, and the like, and also include a medium implemented in a form of a carrier wave (for example, transmission through the Internet). In addition, the computer may include the system for checking quality of laser welding of the present disclosure.

According to the system and method for checking quality of laser welding according to the present disclosure as described above, it is possible to apply a consistent defect determination criterion by determining laser welding quality using an anomaly score predicted based on machine learning.

Compared to variables (upper limit and lower limit height, invasion frequency, invasion area, etc., based on a reference sensing value) that have been applied as conventional defect determination criteria, comparison variables may be reduced to one dimension called an anomaly score, so there is the advantage that a worker does not have to continuously adjust the quality determination criterion.

As a result, it is possible to facilitate maintenance and management of laser welding quality and reduce quality costs.

In addition, by extracting and deleting a process environment trend during a data preprocessing process, it is possible to minimize the influence on the process environment trends.

It is possible to not only delete process environment trends, but also continuously monitor the deleted process environment trends and use the process environment trends to improve the process environment.

Although preferred embodiments of the present disclosure have been described above, the embodiments disclosed in the present disclosure are only for explaining, not limiting, the technical spirit of the present disclosure. Accordingly, the technical spirit of the present disclosure includes not only each disclosed embodiment, but also a combination of the disclosed embodiments, and further, the scope of the technical spirit of the present disclosure is not limited by these embodiments. In addition, many modifications and alterations of the present disclosure may be made by those skilled in the art to which the present disclosure pertains without departing from the spirit and scope of the accompanying claims. In addition, it is to be considered that all of these modifications and alterations fall within the scope of the present disclosure.

What is claimed is:

1. A system for checking quality of laser welding, comprising:
a data input unit configured to receive new radiation data generated during a laser welding process;
an input data preprocessing unit configured to preprocess the new radiation data received by the data input unit; and
a quality determination unit configured to:
input the new radiation data preprocessed by the input data preprocessing unit to a training model that has been learned and stored in advance,
receive an anomaly score,
compare the anomaly score output based on a welding location of the corresponding new radiation data based on preset anomaly conditions for each welding location, and
determine whether the laser welding process in which the corresponding new radiation data is generated is normal or defective.

2. The system of claim 1, further comprising,
to store the training model in advance:
a data collection unit configured to collect radiation data generated during the laser welding process received in advance;
a collected data preprocessing unit configured to perform the preprocessing on the radiation data collected by the data collection unit; and
a learning processing unit configured to perform learning processing by inputting the radiation data preprocessed by the collected data preprocessing unit to a pre-stored machine learning network,
wherein, in the quality determination unit, the training model by the learning processing unit is stored.

3. The system of claim 2, further comprising,
to set outlier conditions for each welding location in advance:
a defect extraction unit configured to extract defective radiation data, which is radiation data by a welding process determined to be defective, from among the radiation data by the data collection unit;
a defective anomaly derivation unit configured to:
analyze the defective radiation data extracted by the defect extraction unit,
classify the defective radiation data for each welding location information based on welding location information included in each defective radiation data,
input the defective radiation data for each welding location information to the training model by the learning processing unit, and
derive the anomaly scores for each welding location information; and
a threshold setting unit configured to use the anomaly scores for each welding location information derived by the defective anomaly derivation unit to set a threshold condition for determining whether the laser welding process is normal or defective.

4. The system of claim 2, wherein the collected data preprocessing unit includes:
a normal extraction unit configured to extract normal radiation data, which is radiation data by a welding process determined to be normal, from among the radiation data by the data collection unit;
a clustering unit configured to perform clustering of the normal radiation data by the normal extraction unit using a pre-stored algorithm;
a cluster optimization unit configured to evaluate clustering by the clustering unit using the pre-stored algorithm and select the most optimal number of clusters;
a centroid setting unit configured to classify the normal radiation data extracted by the normal extraction unit based on the most optimal number of clusters selected by the cluster optimization unit and set centroids of each cluster; and
a learning normalization unit configured to analyze the normal radiation data included in each cluster and delete the normal radiation data corresponding to the centroid to perform data normalization.

5. The system of claim 3, wherein the threshold setting unit includes:
an anomaly determination unit configured to determine whether the anomaly score derived by the defective anomaly derivation unit satisfies a preset over-detection rate setting condition;
a threshold determination unit configured to, based on the determination result of the anomaly determination unit and when the anomaly score derived by the defective anomaly derivation unit satisfies the preset over-detection rate setting condition, determine whether a predetermined condition is satisfied based on preset thresholds for each welding location information; and
a threshold update unit configured to, based on a determination result of the threshold determination unit and when the predetermined condition is satisfied, update threshold setting to the corresponding anomaly score, and perform an operation on all the defective radiation data extracted by the defect extraction unit.

6. The system of claim 5, wherein the quality determination unit is configured to compare the anomaly score, which is an analysis result, based on the threshold setting updated by the threshold determination unit or an initial threshold, and determine that a defect has occurred in the corresponding laser welding process when the anomaly score exceeds a reference.

7. The system of claim 4, wherein the input data preprocessing unit includes:
a similarity processing unit configured to calculate a vector similarity between the centroids of each cluster set by the centroid setting unit and the new radiation data, and search for a centroid having a highest similarity;
a case addition unit configured to add new radiation data corresponding to a cluster having the centroid having the highest similarity by the similarity processing unit;
a centroid resetting unit configured to reset and update the centroid of the cluster to which the new radiation data is added by the case addition unit; and
an input normalization unit configured to analyze the radiation data included in each cluster and delete data corresponding to the centroid to perform the normalization of the new radiation data.

8. The system of claim 7, wherein, when a number of radiation data included in the cluster having the centroid having the highest similarity by the similarity processing unit exceeds a preset maximum value, the case addition unit is configured to delete first received radiation data and add the corresponding new radiation data.

9. A method of checking quality of laser welding using a system for checking quality of laser welding in which each step is performed by arithmetic processing means, the method comprising:
in an inference process, a data inputting step including receiving, by a data input unit, new radiation data generated during a laser welding process;
an input data preprocessing step including preprocessing, by an input data preprocessing unit, the new radiation data received by the data input unit; and
a quality determining step including inputting, by a quality determination unit, the new radiation data preprocessed by the input data preprocessing unit to a training model that has been learned and stored in advance, receiving an anomaly score, comparing the anomaly score output based on a welding location of the corresponding new radiation data based on preset anomaly conditions for each welding location, and determining whether the laser welding process in which the corresponding new radiation data is generated is normal or defective.

10. The method of claim 9, further comprising a learning process to store the training model in advance including:
a data collecting step including collecting, by a data collection unit, radiation data generated during the laser welding process received in advance;
a collected data preprocessing step including performing, by a collected data preprocessing unit, preprocessing the radiation data collected by the data collection unit; and
a learning processing step including performing, by a learning processing unit, learning processing by inputting the radiation data preprocessed by the collected data preprocessing unit to a pre-stored machine learning network are further performed.

11. The method of claim 10, wherein, to set the anomaly conditions for each welding location in advance, in the learning process,
a defect extracting step including extracting, by a defect extraction unit, defective radiation data, which is radiation data by a welding process determined to be defective, from among the radiation data by the data collection unit;
a defective anomaly deriving step including analyzing, by a defective anomaly derivation unit, the defective radiation data extracted by the defect extraction unit, classifying the defective radiation data for each welding location information based on welding location information included in each defective radiation data, inputting the defective radiation data for each welding location information to the training model in the learning processing step, and deriving the anomaly scores for each welding location information; and
an anomaly determining step including determining, by an anomaly determination unit, whether the anomaly score derived by the defective anomaly derivation unit satisfies a preset over-detection rate setting condition;
based on the determination result of the anomaly determining step, and in response to the anomaly score derived by the defective anomaly derivation unit satisfies the preset over-detection rate setting condition, a threshold determining step including determining, by a threshold determination unit, whether a predetermined condition is satisfied based on preset thresholds for each welding location information threshold; and
based on a determination result of the threshold determining step, in response to the predetermined condition being satisfied, a threshold updating step including updating, by a threshold update unit, threshold setting to the corresponding anomaly score are further performed.

12. The method of claim 11, wherein the quality determining step includes comparing, by the quality determination unit, the anomaly score, which is an analysis result, based on the threshold setting updated by the threshold update unit or an initial threshold, and determining that a defect has occurred in the corresponding laser welding process in response to the anomaly score exceeding a reference.

13. The method of claim 10, wherein the collected data preprocessing step includes:
a normal extracting step including extracting, by a normal extraction unit, normal radiation data, which is radiation data by a welding process determined to be normal, from among the radiation data by the data collection unit;
a clustering step including performing, by a clustering unit, clustering of the normal radiation data by the normal extraction unit using a pre-stored algorithm;
a cluster optimization step including evaluating, by a cluster optimization unit, the clustering by the clustering unit using the pre-stored algorithm and selecting the most optimal number of clusters;
a centroid setting step including classifying, by a centroid setting unit, the normal radiation data extracted by the normal extraction unit based on the most optimal number of clusters selected by the cluster optimization unit, and setting a centroid of each cluster; and
a learning normalization step including analyzing, by a learning normalization unit, the normal radiation data included in each cluster and deleting the normal radiation data corresponding to the centroid to perform data normalization.

14. The method of claim 13, wherein the input data preprocessing step includes:
a similarity processing step including calculating, by a similarity processing unit, a vector similarity between the centroids of each cluster set by the centroid setting unit and the new radiation data, and searching for a centroid having a highest similarity;
a case adding step including adding, by a case addition unit, new radiation data corresponding to a cluster having a centroid having the highest similarity by the similarity processing unit;
a centroid resetting unit of resetting and updating, both by a centroid resetting unit, the centroid of the cluster to which the new radiation data is added by the case addition unit; and
an input normalization step including analyzing, by an input normalization unit, the radiation data included in each cluster and deleting data corresponding to the centroid to perform the normalization of the new radiation data.

15. The method of claim 14, wherein, in response to a number of radiation data included in the cluster having the centroid having the highest similarity by the similarity processing unit exceeding a preset maximum value, the case adding step includes deleting, by the case addition unit, first received radiation data is deleted and adding the corresponding new radiation data.
